(19) United States
(12) Patent Application Publication
(10) Pub. No.: US 2025/0116907 A1
(43) Pub. Date: Apr. 10, 2025

(54) Electrophoretic Fluid, Electrophoretic Layer, Display Panel and Preparation Method Therefor, and Electronic Device

(71) Applicant: Huawei Technologies Co., Ltd., Shenzhen (CN)

(72) Inventors: Feng Liao, Dongguan (CN); Tao Wang, Nanjing (CN); Yunsong Hu, Dongguan (CN); Yi Wu, Yokohama (JP); Menghu Zhang, Nanjing (CN)

(21) Appl. No.: 18/989,338

(22) Filed: Dec. 20, 2024

Related U.S. Application Data
(63) Continuation of application No. PCT/CN2023/101067, filed on Jun. 19, 2023.

(30) Foreign Application Priority Data
Jun. 21, 2022 (CN) 202210709499.8

(51) Int. Cl. G02F 1/167; G02F 1/16757

(52) U.S. Cl. CPC G02F 1/167; G02F 1/16757

(57) ABSTRACT

A display panel includes a first substrate, a second substrate, and an electrophoretic layer and a conductive adhesive layer that are located between the first substrate and the second substrate. The first substrate includes a common electrode layer and a color light-filtering layer that are stacked. The second substrate includes a pixel electrode layer. The electrophoretic layer is disposed on a surface of the color light-filtering layer or the common electrode in the first substrate. The electrophoretic layer includes a conductive optical adhesive film and a plurality of electrophoretic units. The electrophoretic units are distributed in the conductive optical adhesive film. The conductive optical adhesive film is directly bonded to the color light-filtering layer or the common electrode. There is no other adhesive layer between the electrophoretic layer and the first substrate. The conductive adhesive layer is disposed between the electrophoretic layer and the second substrate.

### CROSS-REFERENCE TO RELATED APPLICATIONS

This is a continuation of International Patent Application No. PCT/CN2023/101067 filed on Jun. 19, 2023, which claims priority to Chinese Patent Application No. 202210709499.8 filed on Jun. 21, 2022. The disclosures of the aforementioned applications are hereby incorporated by reference in their entireties.

### TECHNICAL FIELD

Embodiments of the present disclosure relate to the field of display technologies, and in particular, to an electrophoretic fluid, an electrophoretic layer, a display panel and a preparation method therefor, and an electronic device.

### BACKGROUND

As various display products enter thousands of households, the concept of healthy display has increasingly attracted attention. Electrophoretic display, as a type of reflective display technology, is characterized by low power consumption, paper-like display, and the like, which meets people's requirements for health and eye protection of display technologies.

An electrophoretic display panel mainly includes a common electrode layer, a pixel electrode layer, and an electrophoretic layer located between the common electrode layer and the pixel electrode layer. A principle of the electrophoretic display is as follows. Ambient light (for example, natural light or a room electric light) is used as a light source, two types of particles with opposite charges in the electrophoretic layer, specifically, black particles and white particles, are driven by an electric field between the common electrode layer and the pixel electrode layer to move to two electrode layers close to the display panel, the black particles absorb incident light and the white particles reflect incident light to display a black-and-white pattern, and the displayed pattern can be changed by changing the electric field. When there is no electric field, the charged particles are suspended in the electrophoretic layer to maintain a displayed image. Such a property is a bistable property, which makes the electrophoretic display panel have a characteristic of low power consumption.

Color electrophoretic display is gradually becoming a mainstream in the industry. Currently, there are mainly two structure solutions for implementing the color electrophoretic display panel. One is that an electrophoretic layer including black particles and white particles and a color light-filtering layer are stacked, and the other is that an electrophoretic layer includes color particles. The industry has explored both of the solutions. The electrophoretic display panel including an electrophoretic layer and a color light-filtering layer has poor display effect due to poor optical indicators such as reflectivity and a color gamut, a serious color cast, and other problems.

### SUMMARY

Embodiments of this application provide an electrophoretic fluid, an electrophoretic layer, a display panel and a preparation method therefor, and an electronic device to improve display effect of the display panel.

To achieve the foregoing objective, this application uses the following technical solutions.

According to a first aspect of embodiments of this application, an electrophoretic fluid is provided, including a conductive optical adhesive and electrophoretic units. The electrophoretic units are dispersed in the conductive optical adhesive.

The electrophoretic fluid provided in this embodiment of this application includes the conductive optical adhesive, and the conductive optical adhesive has properties of electricity conducting, light transmission, bonding, and the like. In this way, a formed electrophoretic layer has a bonding property, and can be directly bonded to another structure. In this case, when the electrophoretic layer is used in a display panel, the electrophoretic layer may be directly bonded to a substrate in the display panel, and no intermediate adhesive layer is needed such that a quantity of adhesive layers can be reduced.

In a possible implementation, a material of the conductive optical adhesive includes a polymer bonding material and a conductive material. A conductive optical adhesive film needs to have properties of electricity conducting, light transmission, bonding, and the like. The polymer bonding material enables the conductive optical adhesive film to have light transmission and bonding capabilities, and the conductive material enables the conductive optical adhesive film to have an electricity-conducting capability.

In a possible implementation, the polymer bonding material includes polyester, polyurethane, epoxy resin, polyether, or siloxane. The polymer bonding material has a wide range of material selection, with low costs and easy implementation.

In a possible implementation, the polymer bonding material includes a fluorine-containing, sulfur-containing, or thiophene-containing polymer. The polymer bonding material has a wide range of material selection with low costs and easy implementation.

In a possible implementation, the conductive material includes at least one of transparent conductive particles, a conductive polymer, or an ionic conductive material. The conductive material has a wide range of material selection, with low costs and easy implementation.

In a possible implementation, a mass fraction of the conductive optical adhesive is 1% to 5%.

In a possible implementation, a volume resistivity of the conductive optical adhesive is 1E8 ohm-centimeters (Ω·cm) to 1E12 Ω·cm. A resistivity of the conductive optical adhesive film is controlled to be 1E8 Ω·cm to 1E12 Ω·cm such that the formed electrophoretic layer can have a good electricity-conducting property.

In a possible implementation, the electrophoretic unit includes a micro-capsule, a micro-cup, or a cofferdam. This is a possible implementation.

In a possible implementation, the electrophoretic fluid is configured to prepare the electrophoretic layer.

According to a second aspect of embodiments of this application, an electrophoretic layer is provided, including a conductive optical adhesive film and a plurality of electrophoretic units. The plurality of electrophoretic units is distributed in the conductive optical adhesive film, and the electrophoretic layer is prepared by using the electrophoretic fluid according to any possible implementation.

The electrophoretic layer provided in this embodiment of this application is prepared by using the electrophoretic fluid according to the first aspect, and beneficial effects of the electrophoretic layer are the same as beneficial effects of the electrophoretic fluid.

In a possible implementation, a mass proportion of the conductive optical adhesive film is 0.3% to 10%. The mass proportion of the conductive optical adhesive film is controlled to be 0.3% to 10% such that the conductive optical adhesive film can have a good bonding property.

In a possible implementation, a refractive index of the conductive optical adhesive film is 1.4 to 1.8. The refractive index of the conductive optical adhesive film is controlled to be 1.4 to 1.8 such that the conductive optical adhesive film can have a good light emitting angle.

In a possible implementation, a transmittance of the conductive optical adhesive film is greater than or equal to 92%. The transmittance of the conductive optical adhesive film is controlled to be at least 92% such that the conductive optical adhesive film can have a good light transmission property.

According to a third aspect of embodiments of this application, a display panel is provided. The display panel may be, for example, an electrophoretic display panel. The display panel includes a first substrate and a second substrate that are disposed opposite to each other, and an electrophoretic layer and a conductive adhesive layer that are located between the first substrate and the second substrate. The first substrate includes a common electrode layer and a color light-filtering layer that are stacked on a first base, and the first substrate may be understood as a color film substrate. The electrophoretic layer is disposed on a surface of the first substrate. The electrophoretic layer may be disposed on a surface of the common electrode layer, or the electrophoretic layer may be disposed on a surface of the color light-filtering layer. The electrophoretic layer may be the electrophoretic layer according to any possible implementation. The electrophoretic layer includes a conductive optical adhesive film and a plurality of electrophoretic units, the plurality of electrophoretic units is distributed in the conductive optical adhesive film, and the conductive optical adhesive film is bonded to the first substrate. In other words, the electrophoretic layer is bonded to the first substrate by using the conductive optical adhesive film. The second substrate includes a pixel electrode layer disposed on a second base, and the second substrate may be understood as an array substrate. The conductive adhesive layer is disposed between the electrophoretic layer and the second substrate, and the conductive adhesive layer is separately bonded to the electrophoretic layer and the second substrate. In other words, the electrophoretic layer is directly bonded to the first substrate, and the electrophoretic layer is bonded to the second substrate by using the conductive adhesive layer.

According to the display panel provided in this embodiment of this application, the electrophoretic layer is directly formed on a surface of the first substrate that includes the color light-filtering layer and the common electrode layer, and the conductive optical adhesive film in the electrophoretic layer is bonded to the first substrate such that the electrophoretic layer can be directly bonded to the first substrate. In this case, there is no need to dispose a conductive optical adhesive layer between the electrophoretic layer and the first substrate such that a quantity of film layers between the color light-filtering layer and the electrophoretic layer is reduced, to reduce a distance between the electrophoretic layer and the color light-filtering layer. In this way, optical crosstalk is reduced, a color cast is eliminated, a color gamut is improved, and reflectivity is improved, to effectively improve display effect of the display panel.

In a possible implementation, a thickness of the conductive adhesive layer is less than 15 micrometers (μm). The thickness of the conductive adhesive layer is set to be less than 15 μm such that a problem of edge diffusion caused by a large thickness of the conductive adhesive layer can be resolved.

In a possible implementation, a surface that is of the electrophoretic layer and that faces the conductive adhesive layer is attached to a surface that is of the conductive adhesive layer and that faces the electrophoretic layer. The surface of the conductive adhesive layer is seamlessly attached to the surface of the electrophoretic layer, and there is no bubble between the two surfaces. This can avoid impact of a bubble on display effect.

In a possible implementation, the pixel electrode layer includes a plurality of pixel electrodes disposed at intervals, the second substrate further includes an electric field shielding layer, the electric field shielding layer is disposed on a side that is of the pixel electrode layer and that faces the first substrate, the conductive adhesive layer covers the electric field shielding layer, the electric field shielding layer has a plurality of openings provided at intervals, and the openings are located above the pixel electrodes. Because the conductive adhesive layer is disposed between the pixel electrode layer and the electrophoretic layer, the presence of the conductive adhesive layer increases a distance between the pixel electrode and the electrophoretic layer, causing greater diffusion of electric field lines. Consequently, a region at an edge of a sub-pixel that is not expected to be affected by an electric field (an adjacent sub-pixel) is affected by an electric field. The electric field shielding layer is disposed on the pixel electrode layer such that the electric field shielding layer can shield the electric field lines in the sub-pixel, to resolve a problem that an adjacent sub-pixel is affected by the electric field because the electric field lines are out of a range of the sub-pixel such as to improve display effect.

In a possible implementation, a thickness of the electric field shielding layer is 2 μm to 12 μm. In this way, the electric field shielding layer can shield an electric field, and the presence of the electric field shielding layer does not cause greater edge diffusion.

In a possible implementation, a material of the electric field shielding layer includes an insulating material. This is a low-cost implementation.

In a possible implementation, a dielectric constant of the electric field shielding layer is 2 to 15. In this way, the electric field shielding layer can have good electric field shielding effect.

In a possible implementation, the electrophoretic layer is disposed on a surface of the common electrode layer. The electrophoretic layer is formed on the common electrode layer. A process is simple and easy to implement.

In a possible implementation, the color light-filtering layer includes a plurality of light-filtering units disposed at intervals, and the plurality of light-filtering units include at least three of a red light-filtering unit, a green light-filtering unit, a blue light-filtering unit, a white light-filtering unit, a magenta light-filtering unit, a cyan light-filtering unit, or a yellow light-filtering unit. The color light-filtering layer may include light-filtering units of a plurality of colors, which are not limited to three primary colors.

According to a fourth aspect of embodiments of this application, a preparation method for a display panel is provided, including providing a first substrate, where the first substrate includes a common electrode layer and a color light-filtering layer that are stacked; forming an electrophoretic layer on a surface that is of the first substrate and on which the color light-filtering layer is formed, where the electrophoretic layer includes a conductive optical adhesive film and a plurality of electrophoretic units, the plurality of electrophoretic units are distributed in the conductive optical adhesive film, the electrophoretic layer is prepared by using the electrophoretic fluid according to any possible implementation, and the conductive optical adhesive film is bonded to the first substrate; providing a second substrate, where the second substrate includes a pixel electrode layer; and forming a conductive adhesive layer, where the electrophoretic layer is bonded to the second substrate by using the conductive adhesive layer.

The preparation method for a display panel provided in this embodiment of this application is used to prepare the display panel according to the third aspect, and beneficial effects of the method are the same as beneficial effects of the display panel.

In a possible implementation, forming an electrophoretic layer on a surface that is of the first substrate and on which the color light-filtering layer is formed includes coating, with the electrophoretic fluid, the surface that is of the first substrate and on which the color light-filtering layer is formed to form an electrophoretic film; and drying the electrophoretic film, where the conductive optical adhesive is solidified into the conductive optical adhesive film. In this way, the formed electrophoretic layer has properties of electricity conducting, bonding, light transmission, and the like.

In a possible implementation, forming a conductive adhesive layer includes forming a frame packaging adhesive film on the second substrate, where the frame packaging adhesive film is located on a periphery of the pixel electrode layer; forming a conductive adhesive film on a side of the pixel electrode layer; attaching the first substrate to the second substrate in alignment, where the conductive adhesive film faces the electrophoretic layer; and solidifying the conductive adhesive film and the frame packaging adhesive film to form the conductive adhesive layer and a frame packaging adhesive layer, where the electrophoretic layer is bonded to the second substrate by using the conductive adhesive layer. The conductive adhesive film is formed on the second substrate, and in this case, a step on a surface of the electrophoretic layer may be eliminated by increasing a thickness of the conductive adhesive film such that a surface of the conductive adhesive layer is seamlessly attached to the surface of the electrophoretic layer, and there is no bubble between the two surfaces. This eliminates impact of a bubble on display effect.

In a possible implementation, forming a conductive adhesive layer includes forming a conductive adhesive film on a surface of the electrophoretic layer; attaching the first substrate to the second substrate in alignment, where the conductive adhesive film faces the pixel electrode layer; forming a frame packaging adhesive film configured to package side surfaces of the first substrate and the second substrate; and solidifying the conductive adhesive film and the frame packaging adhesive film, to form the conductive adhesive layer and a frame packaging adhesive layer, where the electrophoretic layer is bonded to the second substrate by using the conductive adhesive layer. The conductive adhesive film is directly formed on the surface of the electrophoretic layer, and the conductive adhesive film may fill a step on the surface of the electrophoretic layer such that a surface of the conductive adhesive layer is seamlessly attached to the surface of the electrophoretic layer, and there is no bubble between the two surfaces. This avoids impact of a bubble on display effect. A process is simple, efficiency is high, and bonding effect is good. In addition, the prepared conductive adhesive layer does not need to be too thick such that a problem of edge diffusion caused by a thickness of the conductive adhesive layer can be avoided, and display effect of the display panel is good.

In a possible implementation, forming a conductive adhesive layer includes forming a frame packaging adhesive film on the second substrate, where the frame packaging adhesive film is located on a periphery of the pixel electrode layer; attaching the first substrate to the second substrate in alignment, where the electrophoretic layer faces the pixel electrode layer; injecting a conductive adhesive film between the electrophoretic layer and the pixel electrode layer; and solidifying the conductive adhesive film and the frame packaging adhesive film to form the conductive adhesive layer and a frame packaging adhesive layer, where the electrophoretic layer is bonded to the second substrate by using the conductive adhesive layer. After the first substrate is attached to the second substrate in alignment, a gap between the electrophoretic layer and the second substrate is filled with colloid to form the conductive adhesive film. Because the colloid is in a flowable state, the formed conductive adhesive film may fill a step on a surface of the electrophoretic layer such that a surface of the finally formed conductive adhesive layer is seamlessly attached to the surface of the electrophoretic layer, and there is no bubble between the two surfaces. This avoids impact of a bubble on display effect. A process is simple, efficiency is high, and bonding effect is good. In addition, the prepared conductive adhesive layer does not need to be too thick such that a problem of edge diffusion caused by a thickness of the conductive adhesive layer can be avoided, and display effect of the display panel is good.

In a possible implementation, a viscosity of the conductive adhesive film is 5 millipascal-seconds (mPa·s) to 300 mPa·s. Fluidity of the conductive adhesive film may be changed by adjusting the viscosity of the conductive adhesive film such that it is easy to form the conductive adhesive film, and the step on the surface of the electrophoretic layer can be eliminated.

In a possible implementation, a surface that is of the electrophoretic layer and that faces the conductive adhesive layer is attached to a surface that is of the conductive adhesive layer and that faces the electrophoretic layer. The surface of the conductive adhesive layer is seamlessly attached to the surface of the electrophoretic layer, and there is no bubble between the two surfaces. This avoids impact of a bubble on display effect.

In a possible implementation, the second substrate further includes an electric field shielding layer, the electric field shielding layer is disposed on a side of the pixel electrode layer, a thickness of the electric field shielding layer is less than a thickness of the conductive adhesive layer, the pixel electrode layer includes a plurality of pixel electrodes disposed at intervals, the electric field shielding layer has a plurality of openings provided at intervals, and the openings are located above the pixel electrodes. The electric field shielding layer can shield electric field lines in a sub-pixel, to resolve a problem that an adjacent sub-pixel is affected by an electric field because the electric field lines are out of a range of the sub-pixel such as to improve display effect.

In a possible implementation, providing a first substrate includes forming the color light-filtering layer on a first base; and forming the common electrode layer on a side that is of the color light-filtering layer and that is away from the first base. In this way, the electrophoretic layer can be formed on the common electrode, which is easy to implement.

According to a fifth aspect of embodiments of this application, an electronic device is provided, including a display panel and a controller. The display panel is electrically connected to the controller, and the display panel is the display panel according to any possible implementation.

The electronic device provided in this embodiment of this application includes the display panel according to the third aspect, and beneficial effects of the electronic device are the same as beneficial effects of the display panel. Details are not described herein again.

### BRIEF DESCRIPTION OF DRAWINGS

FIG. 1A is a diagram of a framework of an electronic device according to an embodiment of this application;

FIG. 1B is a sectional view along an O1-O2 direction in FIG. 1A according to an embodiment of this application;

FIG. 1C is another sectional view along an O1-O2 direction in FIG. 1A according to an embodiment of this application;

FIG. 2A is a diagram of a structure of a display panel according to an embodiment of this application;

FIG. 2B is a diagram of a structure of another display panel according to an embodiment of this application;

FIG. 3A is a top view of a second substrate according to an embodiment of this application;

FIG. 3B is a sectional view along an M1-M2 direction in FIG. 3A according to an embodiment of this application;

FIG. 3C is a diagram of a structure of a sub-pixel according to an embodiment of this application;

FIG. 4A is a top view of another second substrate according to an embodiment of this application;

FIG. 4B is a diagram of a structure of another sub-pixel according to an embodiment of this application;

FIG. 5A is a diagram of a structure of another display panel according to an embodiment of this application;

FIG. 5B is a top view of a display panel according to an embodiment of this application;

FIG. 6 is a diagram of a procedure of preparing a display panel according to an embodiment of this application;

FIG. 7 to FIG. 10A are diagrams of a process of preparing a display panel according to an embodiment of this application;

FIG. 10B is a diagram of a procedure of preparing a conductive adhesive layer according to an embodiment of this application;

FIG. 11 to FIG. 13A are diagrams of another process of preparing a display panel according to an embodiment of this application;

FIG. 13B is a diagram of another procedure of preparing a conductive adhesive layer according to an embodiment of this application;

FIG. 14A is a diagram of a process of preparing a conductive adhesive layer according to an embodiment of this application; and

FIG. 14B is a diagram of still another procedure of preparing a conductive adhesive layer according to an embodiment of this application.

### REFERENCE NUMERALS

10: first substrate; 11: first base; 12: color light-filtering layer; 13: common electrode layer; 14: over coating; 20: second substrate; 21: second base; 22: pixel circuit layer; 221: pixel circuit; 23: pixel electrode layer; 231: pixel electrode; 24: flattening layer; 25: electric field shielding layer; 251: opening; 30: electrophoretic layer; 31: conductive optical adhesive film; 32: electrophoretic unit; 321: capsule shell; 322: dispersion medium; 323: charged particle; 40: conductive adhesive layer; 40′: conductive adhesive film; 50: frame packaging adhesive layer; 50′: frame packaging adhesive film; 51: hole.

### DESCRIPTION OF EMBODIMENTS

The following describes technical solutions in embodiments of this application with reference to accompanying drawings in embodiments of this application. It is clear that the described embodiments are merely some but not all of embodiments of this application.

Terms such as “first” and “second” below are merely for ease of description, and shall not be understood as an indication or implication of relative importance or implicit indication of a quantity of indicated technical features. Therefore, a feature defined by “first”, “second”, or the like may explicitly or implicitly include one or more features. In descriptions of this application, unless otherwise stated, “a plurality of” means two or more than two.

In addition, in embodiments of this application, orientation terms such as “above”, “below”, “left”, and “right” may include but are not limited to definitions based on illustrated orientations in which components in the accompanying drawings are placed. It should be understood that, these directional terms may be relative concepts. They are used for description and clarification of relative positions, and may vary accordingly depending on a change in the orientations in which the components in the accompanying drawings are placed in the accompanying drawings.

In embodiments of this application, unless otherwise clearly specified and limited, the term “connection” should be understood in a broad sense. For example, the “connection” may be a fixed connection, a detachable connection, or an integrated connection, or may be a direct connection or an indirect connection implemented through an intermediate medium. In addition, the term “coupling” may be a direct electrical connection, or may be an indirect electrical connection through an intermediate medium. The term “contact” may be direct contact or indirect contact through an intermediate medium.

In embodiments of this application, “and/or” describes an association relationship between associated objects and indicates that three relationships may exist. For example, A and/or B may indicate the following cases: Only A exists, both A and B exist, and only B exists, where A and B may be singular or plural. The character “/” generally indicates an “or” relationship between the associated objects.

An embodiment of this application provides an electronic device. The electronic device is, for example, a consumer electronic product, a home electronic product, a vehicle-mounted electronic product, or a financial terminal product. The consumer electronic product is, for example, an e-paper, an e-book, a mobile phone, a tablet computer (pad), a notebook computer, an e-reader, a personal computer (PC), a personal digital assistant (PDA), a desktop display, a smart wearable product (for example, a smart watch or a smart band), a virtual reality (VR) terminal device, an augmented reality (AR) terminal device, or the like. The home electronic product is, for example, a smart door lock, a television, a remote control, a refrigerator, a small household charging appliance (for example, a soy milk maker or a robot vacuum), or the like. The vehicle-mounted electronic product is, for example, a vehicle-mounted navigator, a vehicle-mounted DIGITAL VERSTAILE DISC (DVD), or the like. The financial terminal product is, for example, an automated teller machine (ATM), a self-service terminal, a digital billboard, an e-poster, or the like.

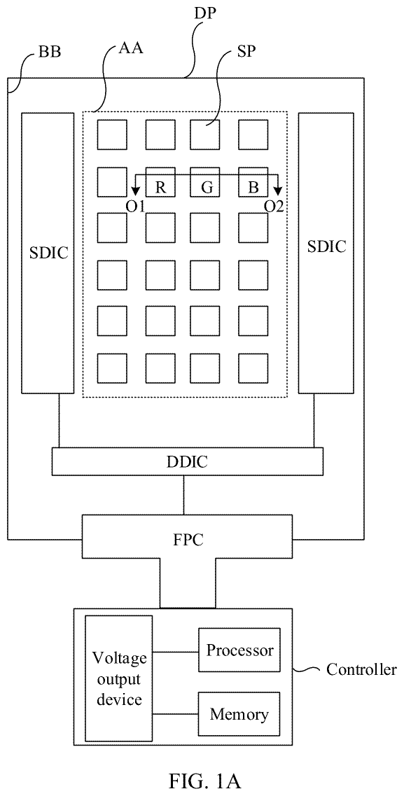

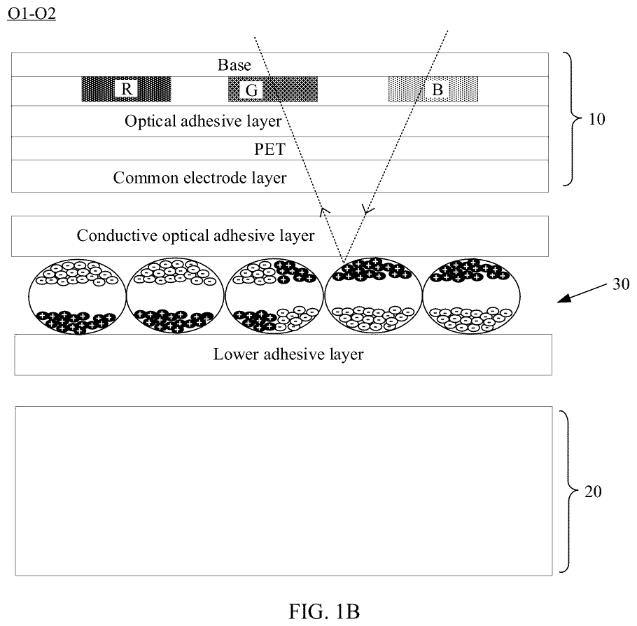

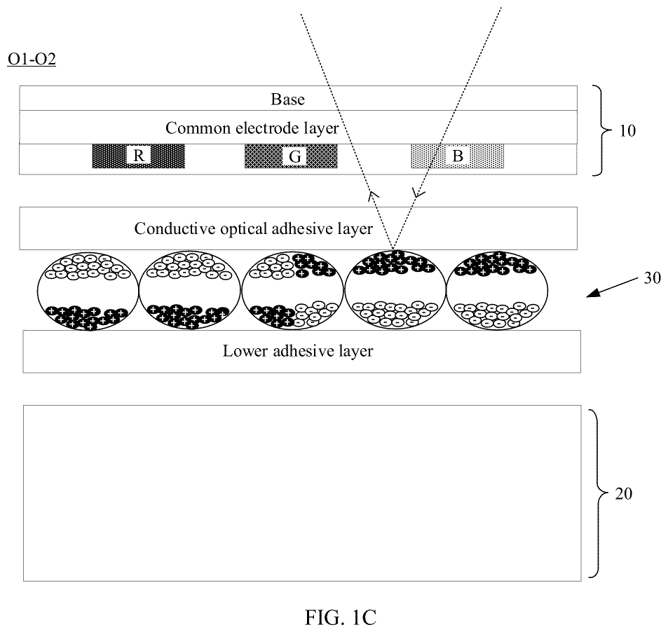

An embodiment of this application provides an electronic device. As shown in FIG. 1A, the electronic device includes a display panel (DP) and a controller, and the display panel DP is electrically connected to the controller.

The DP includes an active area AA and a border area BB located on a periphery of the active area. The border area BB may be disposed around the active area AA, or the border area BB may be located on one or more sides of the active area AA. The active area AA of the DP is used as an active area of the electronic device, and the border area BB of the DP is used as a border area of the electronic device.

A plurality of sub-pixels (SPs) are disposed in the active area AA. The plurality of SPs may be arranged, for example, in an array, and the SPs are configured to provide various information about a displayed image.

A scan driver integrated circuit (SDIC), a display driver integrated circuit (DDIC), and a flexible printed circuit (FPC) are disposed in the border area BB.

The controller is electrically connected to the DP through the FPC, and the FPC provides a connection path for signal transmission between the controller and the display panel DP. Components such as a processor (central processing unit (CPU)), a memory, and a voltage output device may be integrated into the controller.

For a cross-sectional structure of the display panel, in some technologies, as shown in FIG. 1B (a sectional view along an O1-O2 direction in FIG. 1A), the display panel includes a first substrate 10 and a second substrate 20 that are disposed opposite to each other, and an electrophoretic layer 30 disposed between the first substrate 10 and the second substrate 20.

The first substrate 10 includes a base, a color light-filtering layer (for example, including a red light-filtering unit R, a green light-filtering unit G, and a blue light-filtering unit B) disposed on the base, a common electrode layer disposed on a polyethylene terephthalate (PET) layer, and an optical adhesive layer configured to bond the color light-filtering layer (color filter array (CFA)) to the PET.

The electrophoretic layer 30 is bonded to the common electrode layer by using a conductive optical adhesive layer, and is bonded to the second substrate 20 by using a lower adhesive layer.

In the display panel shown in FIG. 1B, the color light-filtering layer is disposed on a side that is of the electrophoretic layer 30 and that faces a display surface such that the display panel can implement color display.

However, because there are film layers such as the optical adhesive layer, the PET, the common electrode layer, and the conductive optical adhesive layer between the color light-filtering layer and the electrophoretic layer 30, a spacing between the color light-filtering layer and the electrophoretic layer 30 is excessively large. When a reflection angle of the electrophoretic layer 30 is fixed, a larger spacing between the color light-filtering layer and the electrophoretic layer 30 indicates a higher probability that light is reflected to an adjacent color light-filtering unit. FIG. 1B is used as an example. A larger spacing between the color light-filtering layer and the electrophoretic layer 30 indicates a higher probability that blue light entering from the blue light-filtering unit B enters the green light-filtering unit G after being reflected by the electrophoretic layer 30. Consequently, a color gamut of the DP is affected, and a display color cast is caused. In addition, a larger quantity of film layers between the color light-filtering layer and the electrophoretic layer 30 indicates greater impact on reflectivity of the electrophoretic layer 30. In this case, an excessively large spacing between the color light-filtering layer and the electrophoretic layer 30 obviously affects display effect of the display panel.

In view of this, in some other technologies, as shown in FIG. 1C (a sectional view along an O1-O2 direction in FIG. 1A), the display panel includes a first substrate 10 and a second substrate 20 that are disposed opposite to each other, and an electrophoretic layer 30 disposed between the first substrate 10 and the second substrate 20.

The first substrate 10 includes a base, a common electrode layer disposed on the base, and a color light-filtering layer (for example, including a red light-filtering unit R, a green light-filtering unit G, and a blue light-filtering unit B) disposed on the common electrode layer.

The electrophoretic layer 30 is bonded to the color light-filtering layer by using a conductive optical adhesive layer, and is bonded to the second substrate 20 by using a lower adhesive layer.

Compared with the display panel shown in FIG. 1B, the display panel shown in FIG. 1C includes the conductive optical adhesive layer between the color light-filtering layer and the electrophoretic layer 30 such that a quantity of film layers between the color light-filtering layer and the electrophoretic layer 30 is reduced, to reduce a distance between the color light-filtering layer and the electrophoretic layer 30.

However, the color light-filtering layer needs to be directly formed on the common electrode layer in a printing manner, a process is difficult, and a yield is low. In addition, another film layer is still disposed between the color light-filtering layer and the electrophoretic layer 30, and display effect cannot be further improved. In this case, optical indicators such as reflectivity and a color gamut still need to be improved.

In view of this, an embodiment of this application provides a display panel. The display panel is, for example, a display panel of electrophoretic display (EPD). In the display panel, an electrophoretic layer 30 is directly bonded to a first substrate 10, and a conductive optical adhesive layer between the electrophoretic layer 30 and the first substrate 10 is removed, to reduce a distance between a color light-filtering layer and the electrophoretic layer 30.

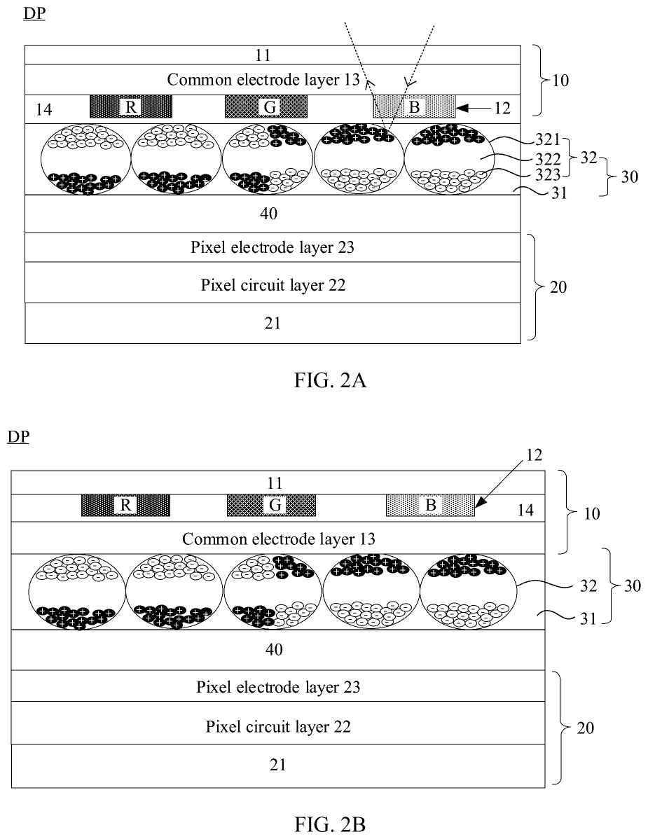

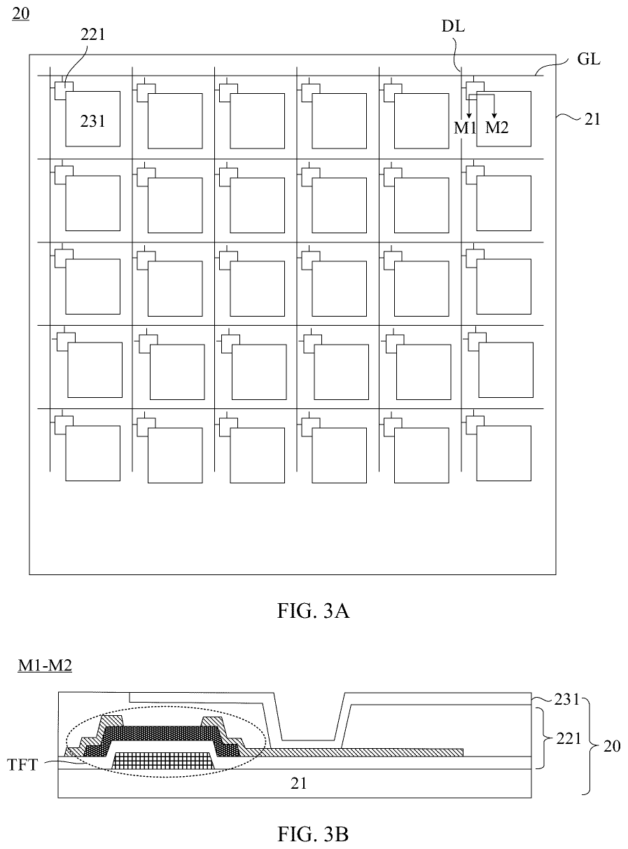

As shown in FIG. 2A, a DP includes a first substrate 10 and a second substrate 20 that are disposed opposite to each other, and an electrophoretic layer 30 disposed between the first substrate 10 and the second substrate 20. The electrophoretic layer 30 is disposed on a surface of the first substrate 10, the electrophoretic layer 30 is in contact with and bonded to the first substrate 10, and no conductive optical adhesive layer is disposed between the electrophoretic layer 30 and the first substrate 10.

The first substrate 10 includes a first base 11, and a color light-filtering layer 12 and a common electrode layer 13 that are disposed on the first base 11 and that are stacked.

In this embodiment of this application, a material of the first base 11 in the first substrate 10 is a transparent insulating material.

In some embodiments, the first base 11 is a hard base.

For example, the material of the first base 11 includes glass.

In some other embodiments, the first base 11 is a flexible base.

For example, the material of the first base 11 includes a polymer resin material. For example, the material of the first base 11 includes polyethylene terephthalate, acrylic resin, polycarbonate, or polypropylene.

The color light-filtering layer 12 in the first substrate 10 includes a plurality of color light-filtering units disposed at intervals. An arrangement manner of the color light-filtering units is the same as an arrangement manner of SPs, and each of the SP is provided with one corresponding color light-filtering unit. The plurality of color light-filtering units includes, for example, a combination of three or four of color light-filtering units such as a red light-filtering unit, a green light-filtering unit, a blue light-filtering unit, a white light-filtering unit, a magenta light-filtering unit, a cyan light-filtering unit, or a yellow light-filtering unit.

For example, as shown in FIG. 2A, the color light-filtering layer 12 includes the red light-filtering unit, the green light-filtering unit, and the blue light-filtering unit.

Alternatively, for example, the color light-filtering layer 12 includes the red light-filtering unit, the green light-filtering unit, the blue light-filtering unit, and the white light-filtering unit. Alternatively, for example, the color light-filtering layer 12 includes the red light-filtering unit, the blue light-filtering unit, the cyan light-filtering unit, and the yellow light-filtering unit. Alternatively, for example, the color light-filtering layer 12 includes the red light-filtering unit, the green light-filtering unit, the cyan light-filtering unit, and the magenta light-filtering unit. Alternatively, for example, the color light-filtering layer 12 includes the green light-filtering unit, the blue light-filtering unit, the magenta light-filtering unit, and the yellow light-filtering unit.

Certainly, an area proportion and a quantity of each type of color light-filtering unit in each type of color light-filtering layer 12 may be properly adjusted according to a requirement. This is not limited in embodiments of this application.

It may be understood that the color light-filtering layer 12 needs to cover at least an active area AA of the DP.

In some embodiments, as shown in FIG. 2A, the first substrate 10 further includes an over coating 14, and the over coating 14 covers the color light-filtering layer 12 to flatten and protect the color light-filtering layer 12.

A material of the over coating 14 may be, for example, a transparent insulating material. For example, the material of the over coating 14 includes a photosensitive resin material.

The common electrode layer 13 covers at least the active area AA of the display panel DP. The common electrode layer 13 may include a plurality of mutually coupled block structures, or the common electrode layer 13 may be of a whole layer structure.

A material of the common electrode layer 13 is a transparent conductive material. For example, the material of the common electrode layer 13 includes an indium tin oxide (ITO), an indium zinc oxide (IZO), an aluminum zinc oxide (AZO), an indium fluorine oxide (IFO), or the like.

It can be learned from the foregoing descriptions of the first substrate 10 that the first substrate 10 may be referred to as a color film substrate. All color film substrates applicable to an electrophoretic display panel in a related technology fall within the protection scope of the first substrate 10 in this embodiment of this application.

Still refer to FIG. 2A. The electrophoretic layer 30 includes a conductive optical adhesive film 31 and a plurality of electrophoretic units 32, and the plurality of electrophoretic units 32 are distributed in the conductive optical adhesive film 31.

The electrophoretic unit 32 may be a micro-capsule, a micro-cup, or a cofferdam. In this embodiment of this application, an example in which the electrophoretic unit 32 is a micro-capsule is used for illustration.

For example, as shown in FIG. 2A, the electrophoretic unit 32 includes a capsule shell 321, a dispersion medium 322 accommodated in the capsule shell, and charged particles 323 dispersed in the dispersion medium.

The capsule shell 321 is light-transmissive and hollow, and has a diameter of 20 μm to 60 μm. A material of the capsule shell 321 includes, for example, methacrylic resin, urea-formaldehyde resin, gum arabic, or the like. The dispersion medium 322 is light-transmissive. A material of the dispersion medium 322 includes, for example, highly viscous silicone oil, a non-polar long-chain hydrocarbon, or the like. The charged particles 323 include a black particle with a negative charge and a white particle with a positive charge.

That the electrophoretic units 32 are distributed in the conductive optical adhesive film 31 may be understood as follows. During formation of the electrophoretic layer 30, the electrophoretic units 32 and a conductive optical adhesive are fully and evenly stirred to form an electrophoretic fluid, and a surface of the first substrate 10 is coated with the electrophoretic fluid to form the electrophoretic layer 30. The conductive optical adhesive in the electrophoretic layer 30 is directly bonded to the first substrate 10, and there is no need to dispose another adhesive layer between the electrophoretic layer 30 and the first substrate 10.

The conductive optical adhesive film 31 needs to have properties of electricity conducting, light transmission, bonding, and the like. For example, a material of the conductive optical adhesive film 31 includes a polymer bonding material and a conductive material. The polymer bonding material enables the conductive optical adhesive film 31 to have light transmission and bonding capabilities, and the conductive material enables the conductive optical adhesive film 31 to have an electricity-conducting capability.

The bonding capability of the conductive optical adhesive film 31 enables the electrophoretic layer 30 to be directly bonded to the first substrate 10.

In some embodiments, as shown in FIG. 2A, the common electrode layer 13 is disposed between the first base 11 and the color light-filtering layer 12.

In this case, the electrophoretic layer 30 is disposed on the color light-filtering layer 12, and the electrophoretic layer 30 is in contact with and bonded to the color light-filtering layer 12. It may be understood that, when the first substrate 10 further includes the over coating 14, the electrophoretic layer 30 is disposed on a surface of the over coating 14, and the electrophoretic layer 30 is in contact with and bonded to the over coating 14.

The color light-filtering layer 12 is disposed on a side that is of the common electrode layer 13 and that is away from the first base 11, and the electrophoretic layer 30 is disposed on a surface of the color light-filtering layer 12. There is no common electrode layer 13 between the electrophoretic layer 30 and the color light-filtering layer 12, and the electrophoretic layer 30 is almost attached and bonded to the color light-filtering layer 12 such that a distance (almost zero) between the electrophoretic layer 30 and the color light-filtering layer 12 can be reduced, to reduce optical crosstalk, eliminate a color cast, and improve reflectivity, so as to effectively improve display effect of the display panel.

In some other embodiments, as shown in FIG. 2B, the color light-filtering layer 12 is disposed between the first base 11 and the common electrode layer 13.

In this case, the electrophoretic layer 30 is disposed on a surface of the common electrode layer 13, and the electrophoretic layer 30 is in contact with and bonded to the common electrode layer 13.

The color light-filtering layer 12 is disposed on a surface of the first base 11. In this case, the color light-filtering layer 12 may be formed on the first base 11, a process is simple, and a yield is high.

Still refer to FIG. 2A. The second substrate 20 includes a second base 21, and a pixel circuit layer 22 and a pixel electrode layer 23 that are sequentially disposed on the second base 21.

The second base 21 may be a hard base, or the second base 21 may be a flexible base. A material of the second base 21 in the display panel may be the same as or different from the material of the first base 11.

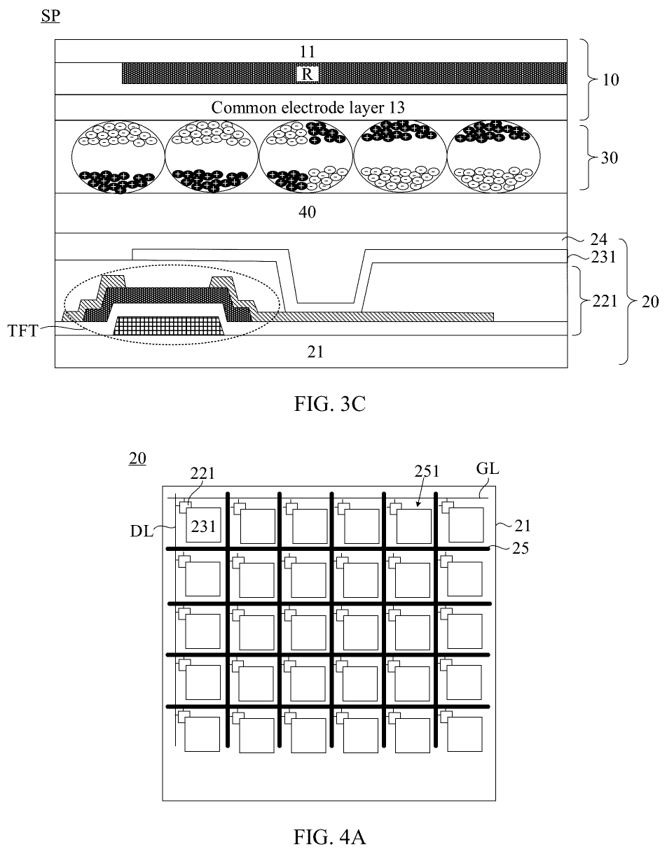

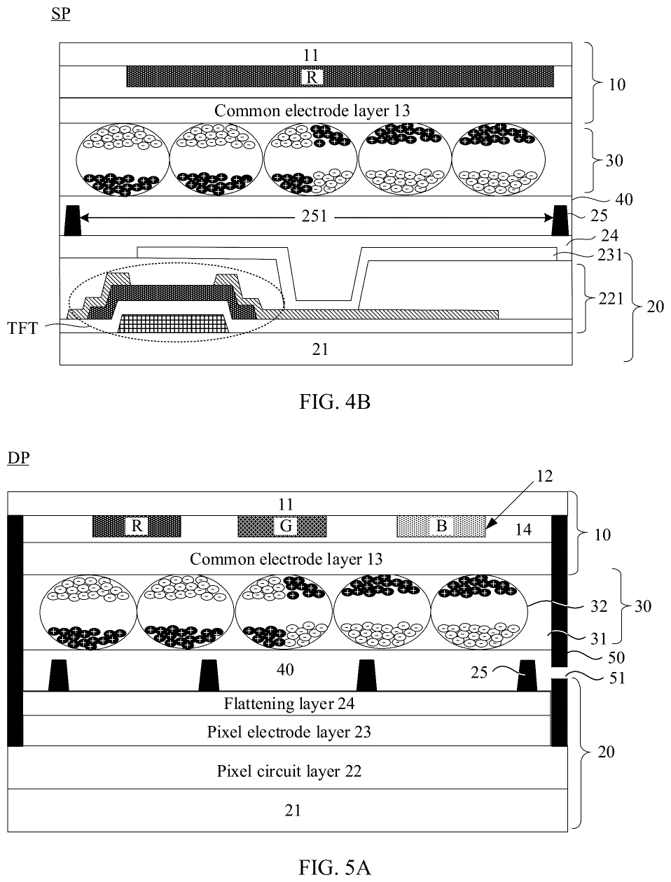

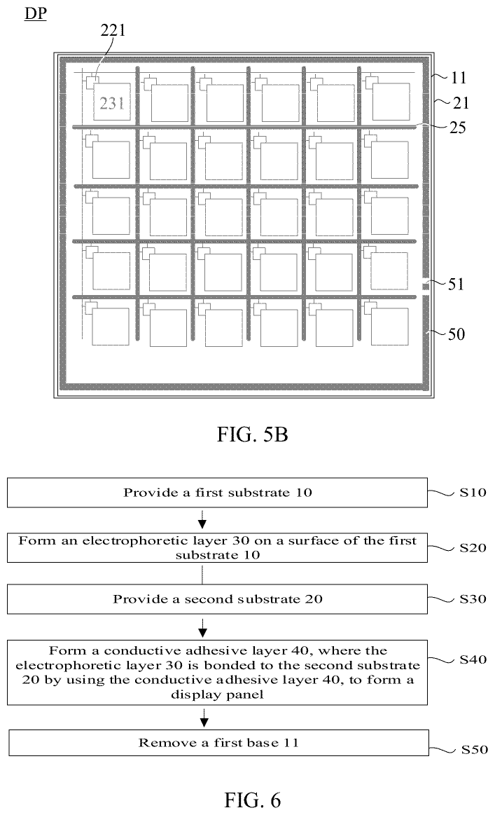

As shown in FIG. 3A, the pixel circuit layer includes a plurality of pixel driver circuits 221 disposed at intervals. An arrangement manner of the pixel driver circuits 221 is the same as the arrangement manner of the sub-pixels, and each sub-pixel is provided with one corresponding pixel driver circuit 221. Certainly, the pixel circuit layer further includes signal lines for transmitting different signals. For example, the pixel circuit layer further includes a plurality of gate lines (GLs) and a plurality of data lines (DLs), and the plurality of GLs and the plurality of DLs are arranged in a cross manner to form a plurality of sub-pixel regions.

Still refer to FIG. 3A. The pixel electrode layer includes a plurality of pixel electrodes 231 disposed at intervals. An arrangement manner of the pixel electrodes 231 is the same as the arrangement manner of the sub-pixels, and each sub-pixel is provided with one corresponding pixel electrode 231. In a same sub-pixel, the pixel electrode 231 is electrically connected to the pixel driver circuit 221.

As shown in FIG. 3B (a sectional view along an M1-M2 direction in FIG. 3A), the pixel driver circuit 221 includes a thin film transistor (TFT), and the pixel electrode 231 is electrically connected to the TFT in the pixel driver circuit 221. The TFT may be an N-type transistor, or the TFT may be a P-type transistor.

Based on this, as shown in FIG. 3C, one SP is used as an example. The SP is provided with a pixel driver circuit 221, a pixel electrode 231, an electrophoretic layer 30, a common electrode layer 13, and a color light-filtering unit (for example, a red light-filtering unit R) that are located between the first base 11 and the second base 21.

In some embodiments, as shown in FIG. 3C, the second substrate 20 further includes a flattening layer 24. The flattening layer 24 covers the pixel electrode layer 23 and is configured to protect and flatten the pixel electrode layer 23.

It can be learned from the foregoing descriptions of the second substrate 20 that the second substrate 20 in this embodiment of this application may be referred to as an array substrate. All array substrates applicable to an electrophoretic display panel in a related technology fall within the protection scope of the second substrate 20 in this embodiment of this application.

Still refer to FIG. 2A. The display panel further includes a conductive adhesive layer 40. The conductive adhesive layer 40 is disposed between the electrophoretic layer 30 and the second substrate 20, and the conductive adhesive layer 40 is separately bonded to the electrophoretic layer 30 and the second substrate 20. In other words, the second substrate 20 is bonded to the electrophoretic layer 30 by using the conductive adhesive layer 40. For example, the pixel electrode layer 23 in the second substrate 20 is electrically connected to the electrophoretic layer 30 through the conductive adhesive layer 40.

The conductive adhesive layer 40 needs to have properties of electricity conducting, bonding, and the like. For example, a material of the conductive adhesive layer 40 includes a common adhesive system material and a conductive material. The common adhesive system material enables the conductive adhesive layer 40 to have a bonding capability, and the conductive material enables the conductive adhesive layer 40 to have an electricity-conducting capability.

A display principle of the foregoing display panel is as follows. If voltages are separately applied to the common electrode layer 13 and the pixel electrode layer 23, the following electrophoresis occurs: the black particle with the negative charge moves, in the dispersion medium 322, to an electrode side to which a positive voltage is applied, and the white particle with the positive charge moves, in the dispersion medium 322, to an electrode side to which a negative voltage is applied. Voltages applied to the pixel electrodes 231 are controlled such that moving statuses of black particles and white particles in the sub-pixels can be controlled. In this way, a reflected amount of light that is incident from the common electrode layer 13 is changed as required such that a desired image can be displayed.

According to the display panel provided in this embodiment of this application, the electrophoretic layer 30 is directly formed on a surface of the first substrate 10 that includes the color light-filtering layer 12 and the common electrode layer 13, and the conductive optical adhesive film 31 in the electrophoretic layer 30 is bonded to the first substrate 10 such that the electrophoretic layer 30 can be directly bonded to the first substrate 10. In this case, there is no need to dispose a conductive optical adhesive layer between the electrophoretic layer 30 and the first substrate 10 such that a quantity of film layers between the color light-filtering layer 12 and the electrophoretic layer 30 is reduced, to reduce a distance between the electrophoretic layer 30 and the color light-filtering layer 12. In this way, optical crosstalk is reduced, a color cast is eliminated, a color gamut is improved, and reflectivity is improved, to effectively improve display effect of the display panel.

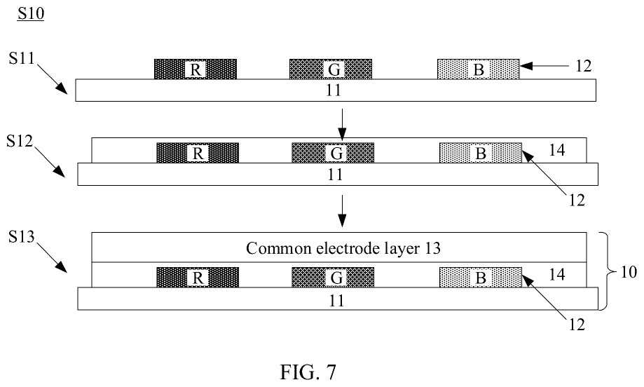

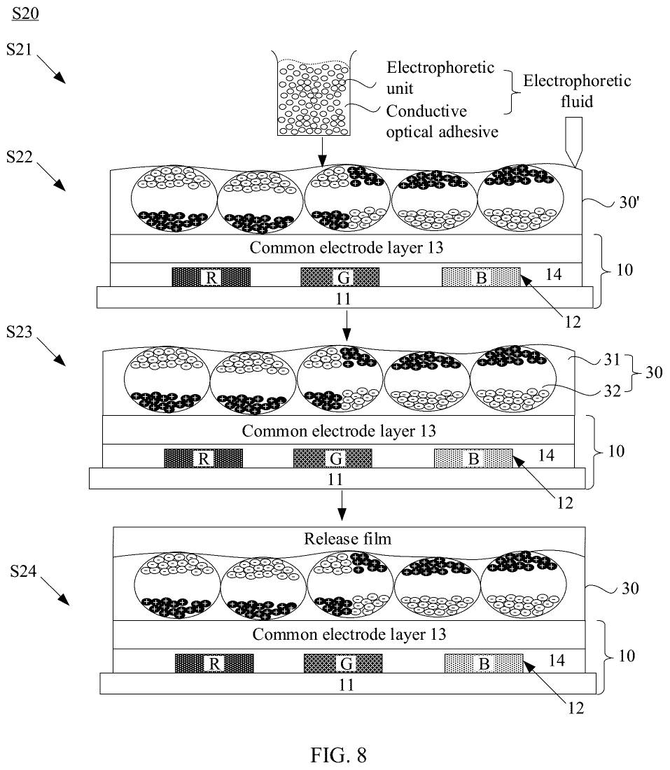

In some embodiments, as shown in FIG. 4A, the second substrate 20 further includes an electric field shielding layer 25. The electric field shielding layer 25 is disposed on a side that is of the pixel electrode layer 23 and that faces the first substrate 10, and the conductive adhesive layer 40 covers the electric field shielding layer 25. The electric field shielding layer 25 has a plurality of openings 251 provided at intervals, and the openings 251 are located above the pixel electrodes 231.

This is equivalent to that the electric field shielding layer 25 is disposed on a periphery of the pixel electrode 231, and the electric field shielding layer 25 is configured to shield an electric field of the pixel electrode 231, to avoid crosstalk between pixel electrodes 231 on two sides of the electric field shielding layer 25.

A material of the electric field shielding layer 25 includes an insulating material. For example, the material of the electric field shielding layer 25 is an inorganic insulating material such as silicon oxide, silicon nitride, a combination of silicon oxide and silicon nitride, or the like. Alternatively, for example, the material of the electric field shielding layer 25 is an organic polymer material such as polyimide, polymethyl methacrylate, polyethylene, or the like.

In some embodiments, a dielectric constant of the material of the electric field shielding layer 25 is 2 to 15, to ensure electric field shielding effect of the electric field shielding layer 25. For example, the dielectric constant of the material of the electric field shielding layer 25 is 3, 4, 5, 6, 7, 8, 9, 10, 11, 12, 13, or 14.

The openings 251 are located above the pixel electrodes 231. A contour of an opening 251 may be greater than a contour of a pixel electrode 231, or a contour of an opening 251 may be less than or equal to a contour of a pixel electrode 231.

An opening 251 may be a non-enclosed opening, for example, openings 251 corresponding to pixel electrodes 231 on a periphery in FIG. 4A. Certainly, the openings corresponding to the pixel electrodes 231 on the periphery may alternatively be enclosed openings, and FIG. 4A is merely an illustration. An opening 251 may be an enclosed opening, for example, openings 251 corresponding to pixel electrodes 231 located in the middle in FIG. 4A.

It should be noted that, for a structure of the electric field shielding layer 25, as shown in FIG. 4A, one opening 251 may correspond to one pixel electrode 231. In other words, each pixel electrode 231 is surrounded by the electric field shielding layer 25. Alternatively, this may be understood as follows: The electric field shielding layer 25 is disposed between any adjacent pixel electrodes 231. Alternatively, one opening 251 may correspond to a plurality of pixel electrodes 231. In other words, a plurality of pixel electrodes 231 are located in a region enclosed by a same opening 251.

As shown in FIG. 4B, that the conductive adhesive layer 40 covers the electric field shielding layer 25 may be understood as follows. A thickness of the conductive adhesive layer 40 is greater than a thickness of the electric field shielding layer 25, and the conductive adhesive layer 40 fills the openings 251 in the electric field shielding layer 25.

The thickness of the electric field shielding layer 25 is related to the thickness of the conductive adhesive layer 40 and a surface step height of the electrophoretic layer 30 (or understood as surface flatness, specifically, a difference between a highest point and a lowest point on the surface). In some embodiments, the thickness of the electric field shielding layer 25=a×the thickness of the conductive adhesive layer 40×an elastic modulus of the conductive adhesive layer 40, where a is 0.2 to 0.4.

For example, the thickness of the conductive adhesive layer 40 is less than 15 μm, and the thickness of the electric field shielding layer 25 is less than 12 μm. For example, the thickness of the conductive adhesive layer 40 is 14 μm, 13 μm, 12 μm, 11 μm, 10 μm, 9 μm, 8 μm, 7 μm, or 6 μm, and the thickness of the electric field shielding layer 25 is 11 μm, 10 μm, 9 μm, 8 μm, 7 μm, 6 μm, 5 μm, 4 μm, or 3 μm.

The electric field shielding layer 25 is disposed in the display panel such that electric fields of pixel electrodes 231 located on two sides of the electric field shielding layer 25 can be shielded, to avoid interference between the pixel electrodes 231 on the two sides of the electric field shielding layer 25.

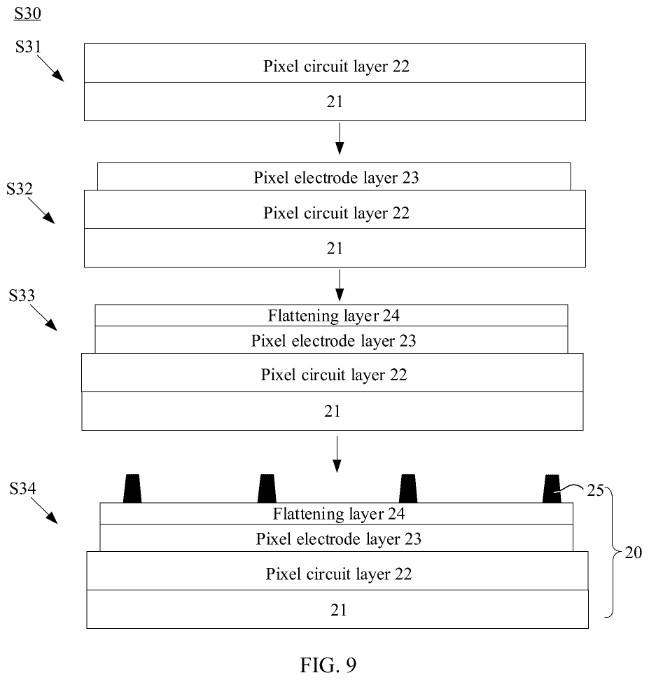

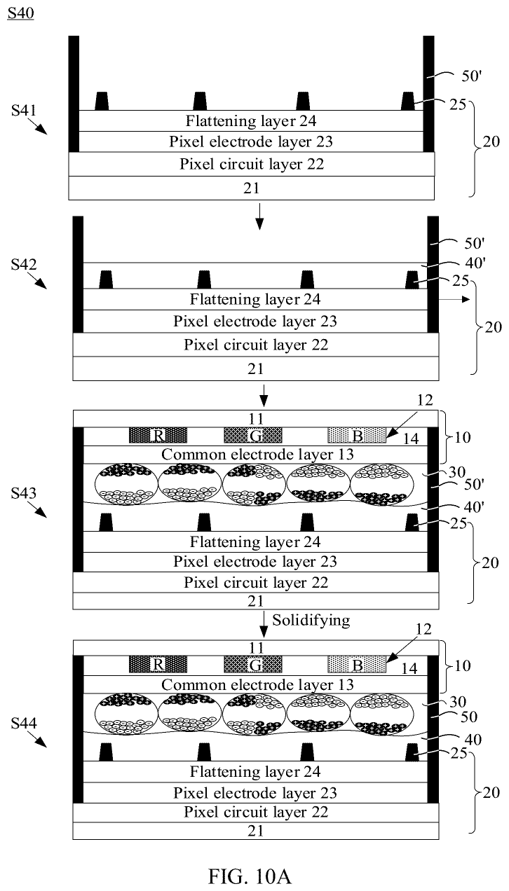

In some embodiments, as shown in FIG. 5A, the display panel further includes a frame packaging adhesive layer 50. The frame packaging adhesive layer 50 is located between the pixel circuit layer 22 and the first base 11 and is disposed close to an edge of the second base 21. As shown in FIG. 5B, the frame packaging adhesive layer 50 is disposed around the edge of the second base 21, and is configured to package a film layer structure located between the first base 11 and the second base 21, to avoid water and oxygen corrosion.

It should be emphasized that, as shown in FIG. 5B, the frame packaging adhesive layer 50 may be provided with a hole, to reserve an overflow opening for various adhesive layers in the display panel during frame packaging. Certainly, the frame packaging adhesive layer 50 may alternatively be a closed pattern. This is not limited in embodiments of this application.

An embodiment of this application further provides a preparation method for a display panel, including the following steps.

S1: Provide a first substrate 10.

As shown in FIG. 2A and FIG. 2B, the first substrate 10 includes a first base 11, and a color light-filtering layer 12 and a common electrode layer 13 that are stacked on the first base 11.

S2: Form an electrophoretic layer 30 on a surface that is of the first substrate 10 and on which the color light-filtering layer 12 is formed.

The electrophoretic layer 30 includes a conductive optical adhesive film 31 and a plurality of electrophoretic units 32, the plurality of electrophoretic units 32 are distributed in the conductive optical adhesive film 31, and the conductive optical adhesive film 31 is bonded to the first substrate 10.

S3: Provide a second substrate 20.

As shown in FIG. 2A, the second substrate 20 includes a pixel electrode layer 23.

In some embodiments, as shown in FIG. 4B, the second substrate 20 further includes an electric field shielding layer 25 disposed on the pixel electrode layer 23.

S4: Form a conductive adhesive layer 40 and a frame packaging adhesive layer 50.

As shown in FIG. 5A, the electrophoretic layer 30 is bonded to the second substrate 20 by using the conductive adhesive layer 40, and the first substrate 10 and the second substrate 20 are packaged by using the frame packaging adhesive layer 50.

The following describes, by using several detailed examples, a display panel and a preparation method therefor provided in embodiments of this application.

### Example 1

An embodiment of this application provides a preparation method for a display panel, to prepare a display panel provided in this embodiment of this application.

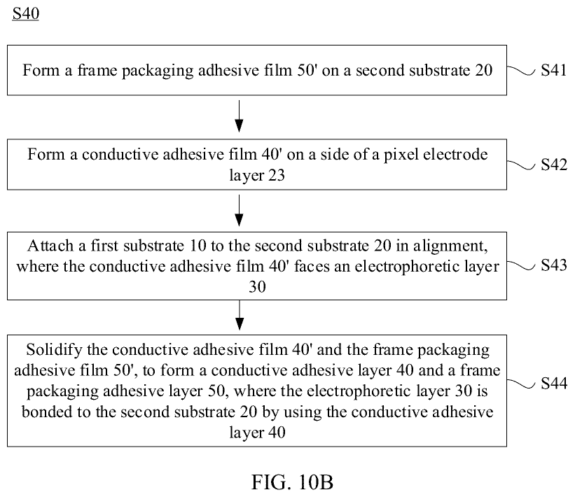

As shown in FIG. 6, the preparation method for a display panel provided in this application includes the following steps.

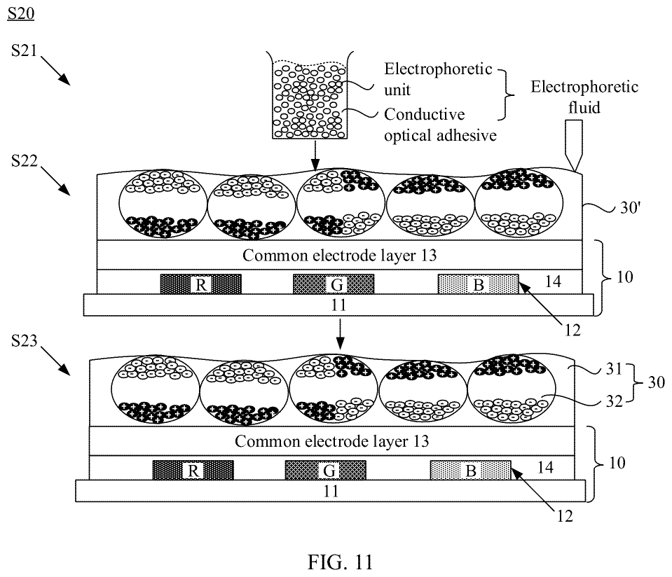

S10: Provide a first substrate 10, as shown in FIG. 7.

The first substrate 10 includes a first base 11, and a color light-filtering layer 12 and a common electrode layer 13 that are stacked on the first base 11. In this embodiment of this application, an example in which the color light-filtering layer 12 is disposed between the first base 11 and the common electrode layer 13 is used for illustration of a stacking sequence of the color light-filtering layer 12 and the common electrode layer 13.

In some embodiments, step S10 includes as follows.

S11: Form the color light-filtering layer 12 on the first base 11.

The first base 11 may be a transparent base such as a glass base or a polymer resin material base.

For example, the color light-filtering layer 12 may be formed in a manner such as coating and exposure development, inkjet printing, screen printing, offset printing, flexographic printing, or the like. The color light-filtering layer 12 includes color light-filtering units of a plurality of colors, and color light-filtering units of a same color may be formed synchronously in a same process.

S12: Form an over coating 14 on the color light-filtering layer 12.

For example, the over coating 14 may be formed by using a coating process, and the over coating 14 protects and flattens the color light-filtering layer 12.

S13: Form the common electrode layer 13 on the over coating 14.

For example, the common electrode layer 13 may be formed in a magnetron sputtering or evaporation manner.

In some embodiments, a thickness of the common electrode layer 13 is 3 nanometer (nm) to 200 nm such that the common electrode layer 13 has a proper transmittance and a proper sheet resistance.

For example, the thickness of the common electrode layer 13 is 10 nm, 20 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm, or 190 nm.

S20: Form an electrophoretic layer 30 on a surface of the first substrate 10, as shown in FIG. 8.

It may be understood that the electrophoretic layer 30 needs to be formed on a surface that is of the first substrate 10 and on which the color light-filtering layer 12 and the common electrode layer 13 are formed. The electrophoretic layer 30 includes a conductive optical adhesive film 31 and a plurality of electrophoretic units 32, the plurality of electrophoretic units 32 are distributed in the conductive optical adhesive film 31, and the conductive optical adhesive film 31 is bonded to the first substrate 10.

In some embodiments, step S20 includes as follows.

S21: Prepare an electrophoretic fluid.

This embodiment of this application provides an electrophoretic fluid. The electrophoretic fluid includes a conductive optical adhesive and electrophoretic units, and the electrophoretic units are dispersed in the conductive optical adhesive.

The conductive optical adhesive may be a water-soluble conductive optical adhesive, or the conductive optical adhesive may be an oil-soluble conductive optical adhesive. A material of the conductive optical adhesive includes a polymer bonding material and a conductive material. The polymer bonding material enables the conductive optical adhesive to have light transmission and bonding capabilities, and the conductive material enables the conductive optical adhesive to have an electricity-conducting capability.

In some embodiments, the polymer bonding material in the conductive optical adhesive is configured to improve a bonding force and a refractive index of the conductive optical adhesive. The polymer bonding material may include a material of a system such as polyester, polyurethane, epoxy resin, polyether, siloxane, or the like, or the polymer bonding material may include a polymer containing fluorine, sulfur, thiophene, or the like.

In some embodiments, the conductive material in the conductive optical adhesive is configured to reduce a volume resistivity of the conductive optical adhesive. The conductive material is, for example, a material with a low resistivity.

For example, the conductive material includes transparent conductive particles. For example, the conductive material includes an antimony tin oxide (ATO), an indium tin oxide (ITO), a carbon nanotube, graphene, or the like.

Alternatively, for example, the conductive material includes a conductive polymer. For example, the conductive material includes poly (3,4-ethylenedioxythiophene):polystyrene sulfonate (PEDOT:PSS).

Alternatively, for example, an ionic conductive material includes an ionic compound. For example, the conductive material includes sodium hydroxide, sodium sulfide, or the like.

Alternatively, for example, the ionic conductive material includes another ionic material (anion or cation), and the ionic material is chemically bonded to the polymer bonding material. For example, the conductive material includes at least one of ions such as an ammonium salt, carboxylate, sulfonate, sulfate, phosphate, borate, an imine salt, phosphonate, or the like.

The material of the conductive optical adhesive is properly selected, and in some embodiments, a mass fraction of the conductive optical adhesive in the electrophoretic fluid is 1% to 5%, to ensure that an electricity-conducting property, a bonding property, and a light transmission property of the finally formed electrophoretic layer 30 meet a requirement such as to improve display effect. For example, the mass fraction of the conductive optical adhesive is 2%, 2.5%, 3%, 3.5%, 4%, or 4.5%.

In some embodiments, the volume resistivity of the conductive optical adhesive is controlled to be 1E8 Ω·cm to 1E12 Ω·cm. A conductive layer of the electrophoretic layer 30 may be adjusted by adjusting the volume resistivity of the conductive optical adhesive to improve display effect. For example, the volume resistivity of the conductive optical adhesive is 1E9 Ω·cm, 1E10 Ω·cm, or 1E11 Ω·cm.

S22: Coat the surface of the first substrate 10 with the electrophoretic fluid to form an electrophoretic film 30′.

For example, the surface of the first substrate 10 (for example, a surface of the common electrode layer 13) may be evenly coated with the electrophoretic fluid in a manner such as roller coating, silk-screen printing, slit coating, screen printing, spin coating, or the like.

A size of the electrophoretic film 30′ is less than a size of the first base 11, but is greater than or equal to a size of the common electrode layer 13.

S23: Dry the electrophoretic film 30′ to form the electrophoretic layer 30.

After the electrophoretic film 30′ is dried, the conductive optical adhesive is solidified into the conductive optical adhesive film 31, and the plurality of electrophoretic units 32 are distributed in the conductive optical adhesive film 31 to form the electrophoretic layer 30. In other words, the electrophoretic layer 30 is prepared by using the foregoing electrophoretic fluid. Based on this, this embodiment of this application further provides an electrophoretic layer, and the electrophoretic layer is prepared by using the electrophoretic fluid provided in this embodiment of this application. For example, the electrophoretic layer is obtained after the electrophoretic fluid forms a film and is solidified.

The material of the conductive optical adhesive is properly selected such that a mass proportion of the conductive optical adhesive film 31 can be 0.3% to 10%, a volume resistivity of the conductive optical adhesive film 31 can be 1E8 Ω·cm to 1E12 Ω·cm, a refractive index of the conductive optical adhesive film 31 can be 1.4 to 1.8, and a transmittance of the conductive optical adhesive film 31 can be greater than or equal to 92%.

For example, the mass proportion of the conductive optical adhesive film 31 in the electrophoretic layer 30 is 1%, 2%, 3%, 4%, 5%, 6%, 7%, 8%, or 9%.

The mass proportion of the conductive optical adhesive film 31 is controlled to be 0.3% to 10% such that the conductive optical adhesive film 31 can have a good bonding property.

For example, the volume resistivity of the conductive optical adhesive film 31 is 1E9 Ω·cm, 1E10 Ω·cm, or 1E11 Ω·cm.

The resistivity of the conductive optical adhesive film 31 is controlled to be 1E8 Ω·cm to 1E12 Ω·cm such that the conductive optical adhesive film 31 can have a good electricity-conducting property.

For example, the refractive index of the conductive optical adhesive film 31 is 1.5, 1.6, or 1.7.

The refractive index of the conductive optical adhesive film 31 is controlled to be 1.4 to 1.8 such that the conductive optical adhesive film 31 can have a good light emitting angle.

For example, the transmittance of the conductive optical adhesive film 31 is 93%, 94%, 95%, 96%, 97%, 98%, 99%, or 99.5%.

The transmittance of the conductive optical adhesive film 31 is controlled to be at least 92% such that the conductive optical adhesive film 31 can have a good light transmission property. In some embodiments, step S20 further includes as follows.

S24: Form a release film on a surface of the electrophoretic layer 30.

For example, the release film is formed by using a coating process. The release film is configured to protect the electrophoretic layer 30, to prevent dust from entering the electrophoretic layer 30, prevent the electrophoretic layer 30 from being damaged due to touch, and prevent humidity of the electrophoretic layer 30 from being changed.

S30: Provide a second substrate 20, as shown in FIG. 9.

The second substrate 20 includes a second base 21, and a pixel circuit layer 22 and a pixel electrode layer 23 that are disposed on the second base 21.

In some embodiments, step S30 includes as follows.

S31: Form the pixel circuit layer 22 on the second base 21.

The pixel circuit layer 22 includes structures such as a plurality of pixel driver circuits disposed at intervals, signal lines electrically connected to the pixel driver circuits, and the like. The pixel driver circuit in the pixel circuit layer 22 is correspondingly located in an active area of the display panel, and the signal line extends to a border area of the display panel.

S32: Form the pixel electrode layer 23 on the pixel circuit layer 22.

The pixel electrode layer 23 includes a plurality of pixel electrodes disposed at intervals. The pixel electrode layer 23 is located in the active area of the display panel, and may further partially extend to the border area of the display panel. However, a coverage area of the pixel electrode layer 23 is less than a coverage area of the pixel circuit layer 22.

S33: Form a flattening layer 24 on the pixel electrode layer 23.

A material of the flattening layer 24 may be, for example, an insulating material. The flattening layer 24 is configured to flatten and fill the pixel electrode layer 23.

S34: Form an electric field shielding layer 25 on the flattening layer 24.

In this case, the formed electric field shielding layer 25 is located on a side that is of the pixel electrode layer 23 and that is away from the second base 21. The electric field shielding layer 25 has a plurality of openings provided at intervals, and the openings are located above the pixel electrodes.

For example, the electric field shielding layer 25 may be formed by using a photoetching process. A thickness of the formed electric field shielding layer 25 in a direction perpendicular to the second base 21 needs to be less than a thickness of a to-be-formed conductive adhesive layer such that the conductive adhesive layer can cover the electric field shielding layer 25.

It should be emphasized that there is no limitation on a sequence of step S10 and step S30. Step S10 may be performed before step S30 is performed. Alternatively, step S30 may be performed before step S10 is performed. Alternatively, step S10 and step S30 may be performed synchronously in different preparation environments. This embodiment of this application is merely an illustration.

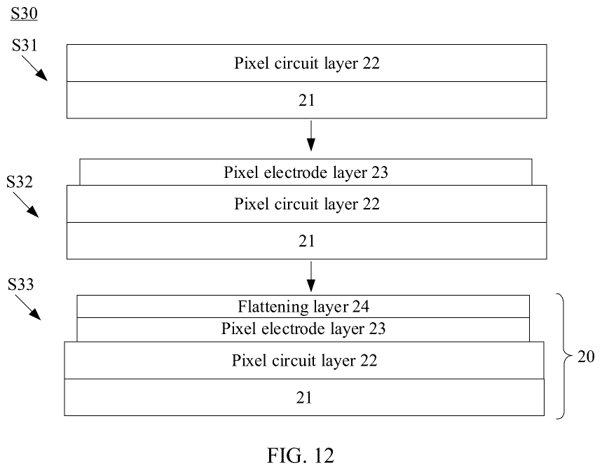

S40: Form a conductive adhesive layer 40, where the electrophoretic layer 30 is bonded to the second substrate 20 by using the conductive adhesive layer 40 to form the display panel, as shown in FIG. 10A.

In some embodiments, as shown in FIG. 10B, step S40 includes as follows.

S41: Form a frame packaging adhesive film 50′ on the second substrate 20.

The frame packaging adhesive film 50′ is located on a periphery of the pixel electrode layer 23, and there may be a gap between the frame packaging adhesive film 50′ and the pixel electrode layer 23.

S42: Form a conductive adhesive film 40′ on a side of the pixel electrode layer 23 (on the flattening layer 24).

For example, the conductive adhesive film 40′ may be formed in a coating or film attaching manner. A material of the conductive adhesive film 40′ may be an optical liquid adhesive (OCR) or an optical clear adhesive (OCA). The conductive adhesive film 40′ needs to cover the electric field shielding layer 25.

In some embodiments, the material of the conductive adhesive film 40′ may be a common adhesive. For example, the material of the conductive adhesive film 40′ includes polymethyl methacrylate, polyurethane, epoxy resin, polyvinyl alcohol, polyvinyl acetate, or the like. The material of the conductive adhesive film 40′ may alternatively be a material with a low refractive index. For example, the material of the conductive adhesive film 40′ includes fluorine-containing polymethyl methacrylate, silane resin, or the like.

In some embodiments, an electricity-conducting property of the conductive adhesive film 40′ is the same as or substantially the same as the electricity-conducting property of the conductive optical adhesive film 31. For example, a resistivity of the conductive adhesive film 40′ is 1E8 Ω·cm to 1E12 Ω·cm.

In some embodiments, the conductive adhesive film 40′ may be made of a material with a low transmittance. For example, the material of the conductive adhesive film 40′ is black glue.

Certainly, the frame packaging adhesive film 50′ may be formed before the conductive adhesive film 40′ is formed. Alternatively, the conductive adhesive film 40′ may be formed before the frame packaging adhesive film 50′ is formed.

S43: Attach the first substrate 10 to the second substrate 20 in alignment, where the conductive adhesive film 40′ faces the electrophoretic layer 30.

A high-precision attaching device is used to attach, in alignment, the first substrate 10 on which the electrophoretic layer 30 is formed to the second substrate 20 on which the frame packaging adhesive film 50′ and the conductive adhesive film 40′ are formed. After the attachment, the frame packaging adhesive film 50′ is in contact with the first base 11 in the first substrate 10, and the conductive adhesive film 40′ is in contact with the electrophoretic layer 30.

It may be understood that, if the release film is formed on the electrophoretic layer 30, the release film needs to be removed before the first substrate 10 is attached to the second substrate 20 in alignment.

S44: Solidify the conductive adhesive film 40′ and the frame packaging adhesive film 50′, to form the conductive adhesive layer 40 and a frame packaging adhesive layer 50, where the electrophoretic layer 30 is bonded to the second substrate 20 by using the conductive adhesive layer 40.

For example, the conductive adhesive film 40′ and the frame packaging adhesive film 50′ are solidified in a manner such as ultraviolet (UV) solidifying, thermal solidifying, light-heat dual solidifying, or the like.

In some embodiments, the formed frame packaging adhesive layer 50 is separately bonded to the first base 11 and the pixel circuit layer 22, and the formed conductive adhesive layer 40 is separately bonded to the electrophoretic layer 30 and the flattening layer 24.

In some embodiments, as shown in FIG. 10A, even if there is an uneven step on a surface of the electrophoretic layer 30, the solidified conductive adhesive layer 40 can be seamlessly attached to the electrophoretic layer 30 by adjusting a thickness of the conductive adhesive film 40′. In other words, a surface that is of the electrophoretic layer 30 and that faces the conductive adhesive layer 40 is attached to a surface that is of the conductive adhesive layer 40 and that faces the electrophoretic layer 30, and there is no bubble between the two surfaces.

In some embodiments, a thickness of the conductive adhesive layer 40 is less than 15 μm. For example, the thickness of the conductive adhesive layer 40 is less than 10 μm.

In some embodiments, when the first base 11 is a hard base, the preparation method for a display panel further includes the following steps.

S50: Remove the first base 11.

For example, the first base 11 may be removed by using a laser lift-off (LLO) process such that the display panel becomes a flexible display panel.

In some embodiments, after the first base 11 is removed, re-formation of a flexible first base is further included such that the display panel becomes a flexible display panel.

Certainly, when the second base 21 is a hard base, the second base 21 may be removed and replaced with a flexible second base such that the display panel becomes a flexible display panel.

In the display panel prepared by using the preparation method for a display panel provided in this embodiment of this application, the electrophoretic layer 30 is disposed on a surface of the first substrate 10 (a color film substrate), and the conductive optical adhesive film 31 in the electrophoretic layer 30 is bonded to the first substrate 10 such that the electrophoretic layer 30 can be directly bonded to the first substrate 10. In this case, there is no need to dispose a conductive optical adhesive layer between the electrophoretic layer 30 and the first substrate 10 such that a quantity of film layers between the color light-filtering layer 12 and the electrophoretic layer 30 is reduced, to reduce a distance between the electrophoretic layer 30 and the color light-filtering layer 12. In this way, optical crosstalk is reduced, a color cast is eliminated, a color gamut is improved, and reflectivity is improved, to effectively improve display effect of the display panel.

On this basis, a thickness of the conductive adhesive layer 40 is increased, to fill a step on a surface of the electrophoretic layer 30 such that a surface of the conductive adhesive layer 40 is seamlessly attached to the surface of the electrophoretic layer 30, and there is no bubble between the two surfaces. This avoids impact of a bubble on display effect.

In addition, in a sub-pixel, an electric field between a pixel electrode 231 and the common electrode layer 13 tends to diffuse, and an electric field range on the pixel electrode 231 is smaller than an electric field range on the common electrode layer 13. A greater distance between the pixel electrode 231 and the electrophoretic layer 30 indicates greater diffusion of electric field lines. This is commonly referred to as edge diffusion in the art. Because the conductive adhesive layer 40 is disposed between the pixel electrode layer 23 and the electrophoretic layer 30, the presence of the conductive adhesive layer 40 increases a distance between the pixel electrode 231 and the electrophoretic layer 30, causing greater diffusion of the electric field lines. Consequently, a region at an edge of the sub-pixel that is not expected to be affected by an electric field (an adjacent sub-pixel) is affected by the electric field. The electric field shielding layer 25 is disposed on the pixel electrode layer 23 such that the electric field shielding layer 25 can shield the electric field lines in the sub-pixel, to resolve a problem that an adjacent sub-pixel is affected by the electric field because the electric field lines are out of a range of the sub-pixel such as to improve display effect.

### Example 2

A main difference between Example 2 and Example 1 is as follows: In Example 1, the conductive adhesive film 40′ is formed on a surface of the flattening layer 24, and in Example 2, a conductive adhesive film 40′ is formed on a surface of an electrophoretic layer 30.

An embodiment of this application provides a preparation method for a display panel, to prepare a display panel provided in this embodiment of this application.

The preparation method for a display panel provided in this application includes the following steps.

S10: Provide a first substrate 10, as shown in FIG. 7.

Step S10 in Example 2 may be the same as step S10 in Example 1. Refer to related descriptions in Example 1. Details are not described herein again.

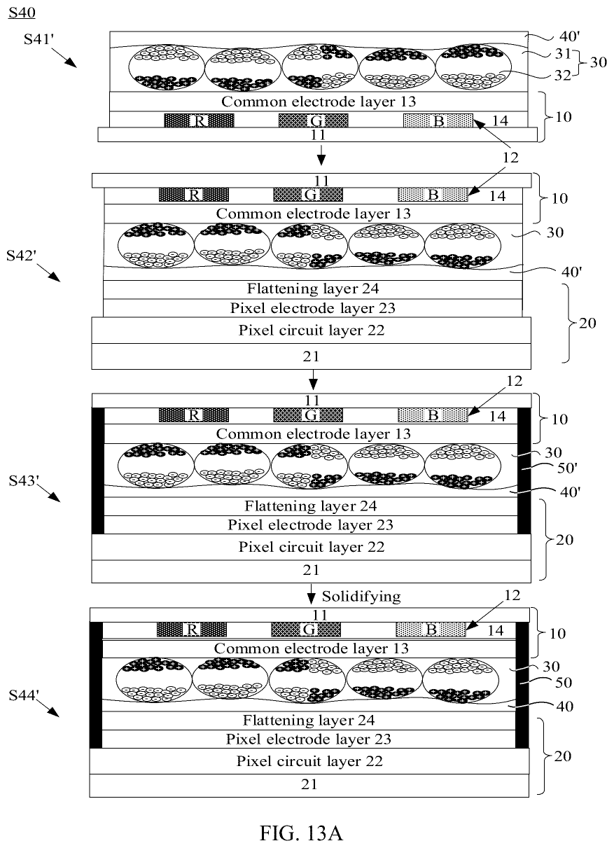

S20: Form an electrophoretic layer 30 on a surface of the first substrate 10, as shown in FIG. 11.

Step S20 in Example 2 may be substantially the same as step S20 in Example 1.

However, in Example 2, there is no need to form a release film on a surface of the electrophoretic layer 30. For a process of forming the electrophoretic layer 30, refer to related descriptions in Example 1. Details are not described herein again.

S30: Provide a second substrate 20, as shown in FIG. 12.

Step S30 in Example 2 may be substantially the same as step S30 in Example 1. In Example 2, an example in which no electric field shielding layer 25 is formed on a surface of a flattening layer 24 is used for illustration. In this case, the finally formed display panel does not include an electric field shielding layer. For a process of forming the second substrate 20, refer to related descriptions in Example 1. Details are not described herein again.

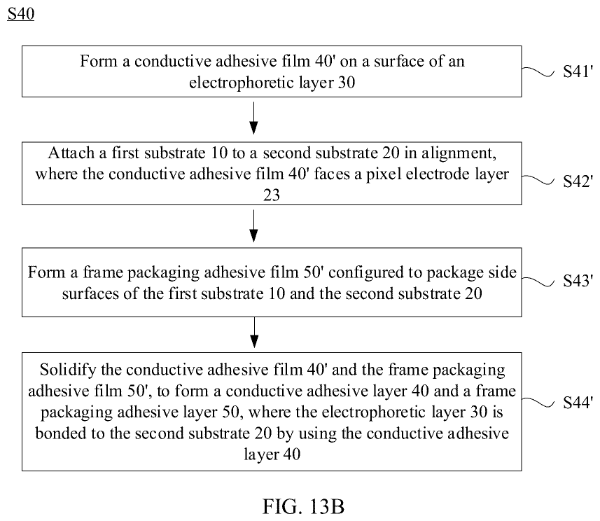

S40: Form a conductive adhesive layer 40, where the electrophoretic layer 30 is bonded to the second substrate 20 by using the conductive adhesive layer 40, to form the display panel, as shown in FIG. 13A.

In some embodiments, as shown in FIG. 13B, step S40 includes as follows.

S41′: Form a conductive adhesive film 40′ on a surface of the electrophoretic layer 30.

For example, the conductive adhesive film 40′ may be formed in a coating or film attaching manner. A material of the conductive adhesive film 40′ may be OCR or an OCA.

In some embodiments, an electricity-conducting property of the conductive adhesive film 40′ is the same as or substantially the same as an electricity-conducting property of a conductive optical adhesive film 31. For example, a resistivity of the conductive adhesive film 40′ is 1E8 Ω·cm to 1E12 Ω·cm.

It may be understood that, step S41′ may be directly performed after step S20 is performed. In other words, after the electrophoretic layer 30 is formed on the surface of the first substrate 10, the conductive adhesive film 40′ is successively formed on the electrophoretic layer 30.

In some embodiments, after the conductive adhesive film 40′ is formed, a release film is further formed. The release film covers the conductive adhesive film 40′.

S42′: Attach the first substrate 10 to the second substrate 20 in alignment, where the conductive adhesive film 40′ faces a pixel electrode layer 23.

In other words, the first substrate 10 on which the conductive adhesive film 40′ is formed is attached to the second substrate 20 in alignment, and the conductive adhesive film 40′ faces the pixel electrode layer 23. After the first substrate 10 is attached to the second substrate 20 in alignment, the conductive adhesive film 40′ is in contact with the flattening layer 24.

It may be understood that, if the release film is formed on the conductive adhesive film 40′, the release film needs to be removed before the first substrate 10 is attached to the second substrate 20 in alignment.

S43′: Form a frame packaging adhesive film 50′ configured to package side surfaces of the first substrate 10 and the second substrate 20.

In some embodiments, as shown in FIG. 13A, the frame packaging adhesive film 50′ is located between a first base 11 and a pixel circuit layer 22, and is located on peripheries of the pixel electrode layer 23 and a common electrode layer 13.

In some other embodiments, the frame packaging adhesive film 50′ is located between an over coating 14 and the pixel circuit layer 22, and is located on peripheries of the pixel electrode layer 23 and the common electrode layer 13.

S44′: Solidify the conductive adhesive film 40′ and the frame packaging adhesive film 50′, to form the conductive adhesive layer 40 and a frame packaging adhesive layer 50, where the electrophoretic layer 30 is bonded to the second substrate 20 by using the conductive adhesive layer 40.

In some embodiments, as shown in FIG. 13A, the display panel provided in this embodiment of this application does not include an electric field shielding layer. In this way, a thickness of the conductive adhesive layer 40 is not linked to a thickness of an electric field shielding layer. The thickness of the conductive adhesive layer 40 is set mainly according to requirements for electricity-conducting and bonding properties such that the thickness of the conductive adhesive layer 40 can be reduced, to resolve a problem of edge diffusion caused by a large thickness of the conductive adhesive layer 40.

In this embodiment of this application, the conductive adhesive film 40′ is directly formed on the surface of the electrophoretic layer 30, and the conductive adhesive film 40′ may fill a step on the surface of the electrophoretic layer 30 such that a surface of the conductive adhesive layer 40 is seamlessly attached to the surface of the electrophoretic layer 30, and there is no bubble between the two surfaces. This avoids impact of a bubble on display effect. A process is simple, efficiency is high, and bonding effect is good. In addition, the prepared conductive adhesive layer 40 does not need to be too thick such that a problem of edge diffusion caused by the thickness of the conductive adhesive layer 40 can be avoided, and display effect of the display panel is good.

### Example 3

A main difference between Example 3 and Example 1 is as follows. In Example 3, a conductive adhesive film 40′ is injected after a first substrate 10 is attached to a second substrate 20 in alignment.

An embodiment of this application provides a preparation method for a display panel, to prepare a display panel provided in this embodiment of this application.

The preparation method for a display panel provided in this application includes the following steps.

S10: Provide a first substrate 10, as shown in FIG. 7.

Step S10 in Example 3 may be the same as step S10 in Example 1. Refer to related descriptions in Example 1. Details are not described herein again.

S20: Form an electrophoretic layer 30 on a surface of the first substrate 10, as shown in FIG. 8.

Step S20 in Example 3 may be the same as step S20 in Example 1. Refer to related descriptions in Example 1. Details are not described herein again.

S30: Provide a second substrate 20, as shown in FIG. 12.

Step S30 in Example 3 may be substantially the same as step S20 in Example 2. Refer to related descriptions in Example 2. Details are not described herein again.

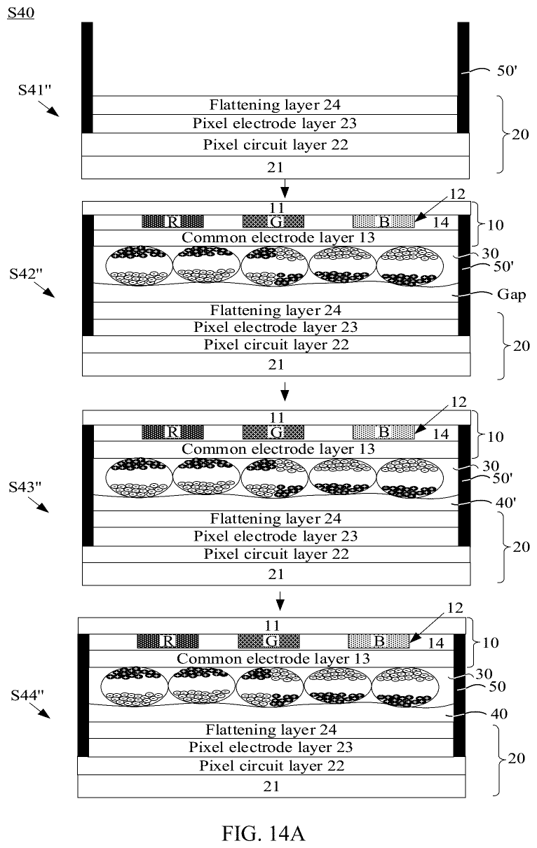

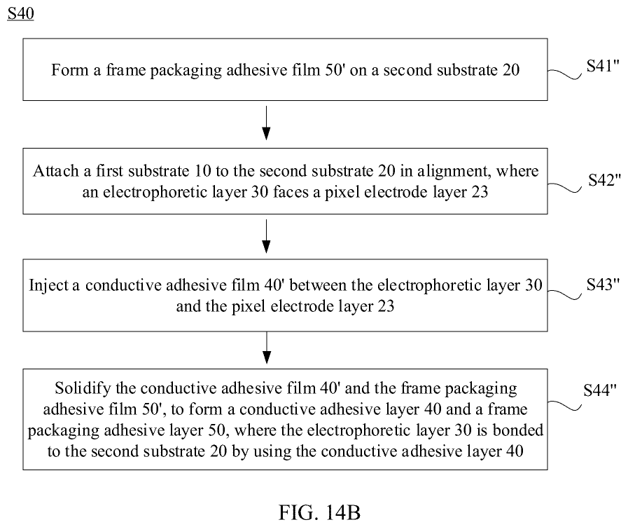

S40: Form a conductive adhesive layer 40, where the electrophoretic layer 30 is bonded to the second substrate 20 by using the conductive adhesive layer 40, to form the display panel, as shown in FIG. 14A.

In some embodiments, as shown in FIG. 14B, step S40 includes as follows.

S41″: Form a frame packaging adhesive film 50′ on the second substrate 20.

The frame packaging adhesive film 50′ is located on a periphery of a pixel electrode layer 23, and there may be a gap between the frame packaging adhesive film 50′ and the pixel electrode layer 23.

S42″: Attach the first substrate 10 to the second substrate 20 in alignment, where the electrophoretic layer 30 faces the pixel electrode layer 23.

The first substrate 10 on which the electrophoretic layer 30 is formed is attached, in alignment, to the second substrate 20 on which the frame packaging adhesive film 50′ is formed. After the attachment, the frame packaging adhesive film 50′ is in contact with a first base 11, an over coating 14, or a common electrode layer 13 in the first substrate 10, and there is a gap between the electrophoretic layer 30 and the second substrate 20.

S43″: Inject a conductive adhesive film 40′ between the electrophoretic layer 30 and the pixel electrode layer 23.

For example, colloid (for example, a conductive adhesive, conductive gel, or a conductive polymer) may be injected into the gap between the electrophoretic layer 30 and the second substrate 20 by using a colloid injection gun, a microfluidic method, or the like, to form the conductive adhesive film 40′. In a process of forming the conductive adhesive film 40′, bubbles between the electrophoretic layer 30 and the conductive adhesive film 40′ are discharged, and an injection opening is sealed.

In some embodiments, viscosity of the conductive adhesive film 40′ is 5 mPa·s to 300 mPa·s. For example, the viscosity of the conductive adhesive film 40′ is 50 mPa·s, 100 mPa·s, 150 mPa·s, 200 mPa·s, or 250 mPa·s.

S44″: Solidify the conductive adhesive film 40′ and the frame packaging adhesive film 50′ to form the conductive adhesive layer 40 and a frame packaging adhesive layer 50, where the electrophoretic layer 30 is bonded to the second substrate 20 by using the conductive adhesive layer 40.

In this embodiment of this application, after the first substrate 10 is attached to the second substrate 20 in alignment, the gap between the electrophoretic layer 30 and the second substrate 20 is filled with the colloid, to form the conductive adhesive film 40′. Because the colloid is in a flowable state, the formed conductive adhesive film 40′ may fill a step on a surface of the electrophoretic layer 30 such that a surface of the finally formed conductive adhesive layer 40 is seamlessly attached to the surface of the electrophoretic layer 30, and there is no bubble between the two surfaces. This avoids impact of a bubble on display effect. A process is simple, efficiency is high, and bonding effect is good. In addition, the prepared conductive adhesive layer 40 does not need to be too thick such that a problem of edge diffusion caused by a thickness of the conductive adhesive layer 40 can be avoided, and display effect of the display panel is good.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. An electrophoretic fluid, comprising:
a conductive optical adhesive, wherein a material of the conductive optical adhesive comprises a polymer bonding material and a conductive material, and wherein a mass fraction of the conductive optical adhesive is 1% to 5%; and
electrophoretic units dispersed in the conductive optical adhesive.

2. The electrophoretic fluid of claim 1, wherein the polymer bonding material comprises polyester, polyurethane, epoxy resin, polyether, or siloxane, and wherein the conductive material comprises transparent conductive particles, a conductive polymer, or an ionic conductive material.

3. The electrophoretic fluid of claim 1, wherein the polymer bonding material comprises a fluorine-containing polymer, a sulfur-containing polymer, or a thiophene-containing polymer.

4. The electrophoretic fluid of claim 1, wherein a volume resistivity of the conductive optical adhesive is 1E8 ohm-centimeters (Ω·cm) to 1E12 Ω·cm.

5. The electrophoretic fluid of claim 1, wherein each of the electrophoretic units comprises a micro-capsule.

6. The electrophoretic fluid of claim 1, wherein each of the electrophoretic units comprises a micro-cup.

7. The electrophoretic fluid of claim 1, wherein each of the electrophoretic units comprises a cofferdam.

8. A display panel, comprising:
a first substrate comprising:
a first surface;
a common electrode layer; and
a color light-filtering layer stacked with the common electrode layer;
a second substrate comprising a pixel electrode layer;
an electrophoretic layer disposed on the first surface and comprising:
a conductive optical adhesive film bonded to the first substrate; and
first electrophoretic units distributed in the conductive optical adhesive film; and
a conductive adhesive layer disposed between the electrophoretic layer and the second substrate and separately bonded to the electrophoretic layer and the second substrate.

9. The display panel of claim 8, wherein a thickness of the conductive adhesive layer is less than 15 micrometers (μm).

10. The display panel of claim 8, wherein the electrophoretic layer comprises a second surface, and wherein the conductive adhesive layer comprises a third surface facing the second surface.

11. The display panel of claim 8, wherein the pixel electrode layer comprises:
a side facing the first substrate; and
a plurality of pixel electrodes disposed at intervals, wherein the second substrate further comprises an electric field shielding layer disposed on the side and comprising a plurality of openings located above the pixel electrodes at intervals, and wherein the conductive adhesive layer covers the electric field shielding layer.

12. The display panel of claim 11, wherein a thickness of the electric field shielding layer is 2 micrometers (μm) to 12 μm.

13. The display panel of claim 11, wherein a dielectric constant of the electric field shielding layer is 2 to 15.

14. The display panel of claim 8, wherein the electrophoretic layer is disposed on a second surface of the common electrode layer.

15. The display panel of claim 8, further comprising a controller electrically coupled to the display panel.

16. A method comprising:
providing a first substrate comprising a first surface;
preparing an electrophoretic layer using an electrophoretic fluid, wherein the electrophoretic fluid comprises a conductive optical adhesive and electrophoretic units dispersed in the conductive optical adhesive, and wherein a mass fraction of the conductive optical adhesive is 1% to 5%;
forming the electrophoretic layer on the first surface;
providing a second substrate comprising a pixel electrode layer; and
forming a conductive adhesive layer bonded to the second substrate.

17. The method of claim 16, wherein forming the electrophoretic layer comprises:
coating the first surface with the electrophoretic fluid to form an electrophoretic film; and
drying the electrophoretic film.

18. The method of claim 16, wherein forming the conductive adhesive layer comprises:
forming a frame packaging adhesive film on a periphery of the pixel electrode layer;
forming a conductive adhesive film on a side of the pixel electrode layer;
attaching the first substrate to the second substrate in alignment so that the conductive adhesive film faces the electrophoretic layer; and
solidifying the conductive adhesive film and the frame packaging adhesive film to form the conductive adhesive layer and a frame packaging adhesive layer.

19. The method of claim 16, wherein forming the conductive adhesive layer comprises:
forming a conductive adhesive film on a second surface of the electrophoretic layer;
attaching the first substrate to the second substrate in alignment so that the conductive adhesive film faces the pixel electrode layer;
forming a frame packaging adhesive film to package side surfaces of the first substrate and the second substrate; and
solidifying the conductive adhesive film and the frame packaging adhesive film to form the conductive adhesive layer and a frame packaging adhesive layer.

20. The method of claim 16, further comprising injecting the conductive adhesive film between the electrophoretic layer and the pixel electrode layer.
